(19) United States
(12) Patent Application Publication
(10) Pub. No.: US 2020/0153038 A1
(43) Pub. Date: May 14, 2020

(54) RECHARGEABLE LITHIUM-ION BATTERY

(71) Applicant: UTI Limited Partnership, Calgary (CA)

(72) Inventors: Venkataraman THANGADURAI, Calgary (CA); Kyle HOFSTETTER, Calgary (CA); Alfred Junio SAMSON, Calgary (CA)

(21) Appl. No.: 16/609,620

(22) PCT Filed: May 1, 2018
(86) PCT No.: PCT/CA2018/050514

§ 371 Date: Oct. 30, 2019

Related U.S. Application Data
(60) Provisional application No. 62/492,338, filed on May 1, 2017.

(51) Int. Cl. H01M 10/0562; H01M 12/08; H01M 4/86; H01M 10/052; H01M 10/36; H01M 4/80; C01G 35/00

(52) U.S. Cl. CPC H01M 10/0562; H01M 12/08; H01M 4/8605; H01M 10/052; H01M 2004/028; H01M 4/80; C01G 35/006; H01M 2300/0071; H01M 10/36

(57) ABSTRACT

Disclosed herein is a re-chargeable Li-air battery cell comprising a Li-based garnet-type Li_{6.5}La_{2.5}Ba_{0.5}ZrTaO₁₂ (LLBZT) electrolyte and the like. The Li-rich LLBZT is adjacent to a ceramic wall which, in turn, is adjacent to a porous or dense cathode which, in turn, is adjacent to a porous or dense current-collecting layer. Two or more re-chargeable Li-air battery cells comprising LLBZT may be connected in series. The barium component of the LLBZT may be substituted or doped with an alkaline rare earth metal, for example one of beryllium, magnesium, calcium, strontium, and radium. The tantalum component of LLBZT may be substituted or doped with niobium or lanthanum.

### TECHNICAL FIELD

This disclosure generally relates to energy storage apparatus. More specifically, this disclosure pertains to Li-rich garnet-type electrolytes for use in configuring aqueous Li—O₂ and Li—S batteries.

### BACKGROUND

At present, energy storage from renewable sources such as solar, wind and hydro energy plays a vital role for the protection of planet earth from global warming due to greenhouse gas emissions. Various electrochemical devices, including fuel cells (energy conversion from fuels), battery (energy storage in the form of chemical energy), capacitors (electricity directly stored in the form electrical charge) and reverse fuel cells (convert the fuel cell by-products such as CO₂ and water to fuels) have been developed. Among them, batteries have drawn much attention due to their ability to provide power, ranging from pacemaker, portable electronics (10-100 Wh), long-range electric vehicles (20-90 kWh) and support peak power demand at the grid (MWh). Currently, several battery chemistries, including Ni—Cd, Ni-MH lead-acid, and LiCO₂ are being considered. Lead-acid, Ni-MH, and Ni—Cd batteries lack the specific energy density, leading to heavy designs for low energy output. State-of-the-art Li⁺ ion batteries based on organic polymers, lack the ability for high cyclability, chemical and electrochemical stability, and pose safety concerns due to flammability and likelihood of explosion. To overcome these hurdles of organic polymer-membrane-based Li⁺ ion batteries, there is a need for high-temperature-stable battery chemistry that can reach energy densities comparable to that of gasoline. Replacing flammable organic polymers with solid-state (ceramic) electrolytes can eliminate the long-term safety issues in the current Li-ion battery chemistry.

Li is the lightest known metal and exhibits the highest theoretical capacity of 3860 mAh/g with the lowest redox potential of −3.04 V vs. standard hydrogen electrode. Thus, there is ongoing demand to assess metallic Li for use as battery anodes. However, metallic Li electrodes form dendrites in the organic-polymer-based secondary Li⁺ ion batteries, especially at higher rates of charging/discharging current densities. Attempts have also been made to use the Li anodes in the next generation, beyond Li-ion batteries such as Li—O₂ and Li—S. Such attempts have focused on planar battery cell configurations. However, the bottleneck in those configurations is the chemical instability of lithium when in contact with organic, inorganic, and aqueous electrolytes that impede progress of such configured batteries.

Recently, there have been attempts to increase energy density of the Li⁺ ion batteries using non-traditional intercalation electrodes chemistry. For example, Li—O₂ and Li—S chemistry provide theoretical energy density that can compete with that of gasoline. Li—O₂ cell shows theoretical energy density about 10× that of state-of-the-art Li⁺ ion polymer-membrane, graphite anode and LiCoO₂ cathode based batteries. This high specific energy density is from the fact that the oxygen required does not need to be stored onboard, keeping the configuration lightweight with reasonable voltage output. The battery chemistry of Li—O₂ typically relies on a four-electron process. However, various chemistry processes can occur depending on the chemical composition and pH of the electrolyte of the cell. Furthermore, their practical capacity is also found to be much lower than expected theoretical values. To improve the performance of Li—O₂ and Li—S cells, novel electrode materials with high electrochemical activity and huge surface area are being investigated. One of the key challenges is instability of elemental lithium towards the electrolyte in the Li—O₂ and Li—S batteries. Lithium reacts with organic polymer membranes in non-aqueous and aqueous electrolyte Li—O₂ cells.

Reactions with polysulphide discharge products have been well-known in the Li—S batteries. Development of suitable solid electrolytes will be the key to allowing for successful electrochemical reactions to occur in both Li—O₂ and Li—S batteries. For aqueous Li—O₂ batteries, the electrolyte needs to have high Li-ion conductivity and stability in aqueous solutions and in contact with elemental lithium. Among the various known solid Li-ion electrolytes, perovskite-type (Li,La)TiO₃, NASICON-type Li_{1+(x+y)}Ti₂₋ₓAlₓP_{3-y}Si_{y}O₁₂, LISICON-type Li₂₊₂ₓZn₁₋ₓGeO₄ and garnet-type Li₅La₃Ta₂O₁₂ and Li₇La₃Zr₂O₁₂ have been considered for all solid state batteries. However, Ti-based NASICON and perovskites structure solid electrolytes lack the stability against lithium metal due to the reduction of Ti⁴⁺ to Ti³⁺, which leads to electronic conduction in the electrolyte. LISICON structured Li₂₊₂ₓZn₁₋ₓGeO₄ are also not stable with elemental lithium due to the reduction of Ge⁴⁺.

### SUMMARY

Some embodiments of the present disclosure relate to Li-rich garnet-type Li_{6.5}La_{2.5}Ba_{0.5}ZrTaO₁₂ (LLBZT) electrolytes. The LLBZT electrolyte is characterized as a Li-protecting layer suitable for use in aqueous Li—O₂ batteries. AC impedance spectroscopy and DC electrical measurements, variable temperature powder X-ray diffraction (HT-PXRD), scanning electron microscopy (SEM), and thermogravimetric analyses (TGA) were used to investigate the electrochemical and chemical properties of Li/LLBZT and LLBZT/aqueous interfaces. Stable open circuit voltage (OCV) of ˜3V was observed for Li/LLBZT/0.1MLiOH, Li/LLBZT/1MLiOH and Li/LLBZT/1MLiCl at 25° C. A DC galvanostatic Li plating/stripping cycle at varying constant current density was performed and the area specific polarization resistance (ASR) for Li⁺ ion charge transfer was found to be 473 Ωcm² at 25° C. The impedance of LLBZT is found to be improved after treating the samples with 1 M LiOH, and 1 M LiCl, and retains its crystal structure and electrochemical stability with Li. Accordingly, Li-rich LLBZT garnet can be successfully employed in next-generation-beyond Li⁺ ion batteries.

### BRIEF DESCRIPTION OF THE FIGURES

The embodiments of the present disclosure will be described with reference to the following drawings in which:

FIG. 1A illustrates an example of an experimental design for a Li/Li_{6.5}La_{2.5}Ba_{0.5}ZrTaO₁₂ (LLBZT)/Li cell according to an embodiment of the present disclosure, FIG. 1B illustrates an example of an experimental design for a Li/LLBZT/aqueous solution cell according to another embodiment of the present disclosure, and FIG. 10 illustrates an example of an experimental design for an aqueous/LLBZT/aqueous solution cell used for characterization of Li-rich garnet-type LLBZT for a Li-aqueous battery according to another embodiment of the present disclosure;

FIG. 2 shows charts generated while plating and stripping Li using a symmetrical LLBZT/Li cell at 39 μA cm⁻² current density (top panel), at 84 μA cm⁻² current density (middle panel), and at 169 μA cm⁻² current density (bottom panel), all at 25° C. and using the experimental design illustrated in FIG. 1A;

FIG. 3 is a chart showing Arrhenius plots of bulk Li-ion conductivity for LLBZT with the experimental design illustrated in FIG. 1A using Li-ion blocking Au electrodes;

FIG. 4 is a chart showing open circuit AC impedance plots obtained for symmetrical cell before and after the cycling test using the experimental design illustrated in FIG. 1A;

FIG. 5A is a chart showing open circuit impedance plots obtained for H₂O/Li_{6.5}La_{2.5}Ba_{0.5}ZrTaO₁₂ (LLBZT)/H₂O using the experimental design illustrated in FIG. 1, while FIG. 5C is a chart showing open circuit impedance plots obtained for D₂O/Li_{6.5}La_{2.5}Ba_{0.5}ZrTaO₁₂ (LLBZT)/D2O using the experimental design illustrated in FIG. 10;

FIG. 6A is a chart showing open circuit impedance plots obtained for 1M LiOH/Li_{6.5}La_{2.5}Ba_{0.5}ZrTaO₁₂ (LLBZT)/1M LiOH using the experimental design illustrated in FIG. 10, while FIG. 6B is a chart showing open circuit impedance plots obtained for 1M LiCl/Li_{6.5}La_{2.5}Ba_{0.5}ZrTaO₁₂ (LLBZT)/1M LiCl for 10 days using the experimental design illustrated in FIG. 10;

FIG. 7 is a chart showing the variation of electrical conductivity obtained at 1 MHz for Li_{6.5}La_{2.5}Ba_{0.5}ZrTaO₁₂ under H₂O, D₂O, 1M LiOH and 1M LiCl at room temperature;

FIG. 8 are charts showing variation of open circuit voltage (OCV) for Li/Li_{6.5}La_{2.5} Ba_{0.5}ZrTaO₁₂/0.1 M LiOH (top panel), Li/i_{6.5}La_{2.5}Ba_{0.5}ZrTaO₁₂/1M LiOH (middle panel), and Li/Li_{6.5}La_{2.5}Ba_{0.5}ZrTaO₁₂/1M LiCl (bottom panel) as a function of time using the experimental design illustrated in FIG. 1B,

FIG. 9A is a chart showing the stability of the OCV of the cell before and after short circuit testing using the experimental design illustrated in FIG. 1B, while FIG. 9B shows the impedance of the cell. The same garnet sample was used in all three measurements for both sets of data while the solutions were varied in the sequence 0.1M LiOH, 1M LiOH, and 1M LiCl using the experimental design illustrated in FIG. 1B;

FIGS. 10A and 10B are charts illustrating comparisons of TGA curves of Li_{6.5}La_{2.5}Ba_{0.5}ZrTaO₁₂ after the chemical stability test using the solutions employed in AC impedance spectroscopy study. For comparison, TGA of as-prepared sample is also shown. Asterisks (*) indicate temperatures at which variable temperature PXRD were performed;

FIGS. 11A and 11B are charts illustrating comparisons of TGA curves of Li_{6.5}La_{2.5}Ba_{0.5}ZrTaO₁₂ after the chemical stability test using the solutions employed in AC impedance spectroscopy study. For comparison, TGA of as-prepared sample is also shown. Asterisks (*) indicate temperatures at which variable temperature PXRD were performed;

FIG. 12 is a chart illustrating a comparison of TGA curves of Li_{6.5}La_{2.5}Ba_{0.5}ZrTaO₁₂ after the chemical stability test using the solutions employed in AC impedance spectroscopy study. For comparison, TGA of as-prepared sample is also shown. Asterisks (*) indicate temperatures at which variable temperature PXRD were performed;

FIGS. 13A-13F are examples of scanning electron microscopy (SEM) images of Li_{6.5}La_{2.5}Ba_{0.5}ZrTaO₁₂ before and after the chemical stability tests wherein FIGS. 13A and 13B are as prepared samples (FIG. 13B is a 10-fold higher magnification of FIG. 13A), FIGS. 13C and 13D are water samples (FIG. 13D is a 10-fold higher magnification of FIG. 13C), and FIGS. 13E and 13F are D2O samples (FIG. 13F is a 10-fold higher magnification of FIG. 13E);

FIGS. 14A-14D are examples of scanning electron microscopy (SEM) images of Li_{6.5}La_{2.5}Ba_{0.5}ZrTaO₁₂ after and before the chemical stability tests wherein FIGS. 14A and 14B are 1M LiOH samples (FIG. 14B is a 10-fold higher magnification of FIG. 14A), and FIGS. 14C and 14D are 1M LiCl samples (FIG. 14D is a 10-fold higher magnification of FIG. 140);

FIG. 15 are charts showing powder X-ray diffraction (PXRD) patterns of Li_{6.5}La_{2.5}Ba_{0.5}ZrTaO₁₂ samples after soaking in as-prepared (top panel), water (2^{nd} panel), D2O (3rd panel), 1M LiOH (4th panel), and 1 M LiCl for 5 days (5^{th} panel). For comparison, simulated PXRD of the parent Li₅La₃Nb₂O₁₂ garnet phase is shown in the bottom panel;

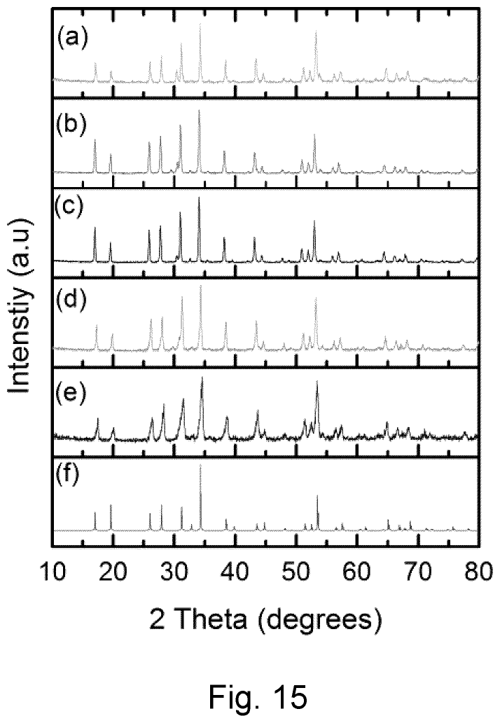

FIG. 16 are charts illustrating in-situ variable temperature powder X-ray diffraction (PXRD) patterns at different temperatures of a Li_{6.5}La_{2.5}Ba_{0.5}ZrTaO₁₂ sample after soaking in water;

FIG. 17 are charts illustrating in-situ variable temperature powder X-ray diffraction (PXRD) patterns at different temperatures of a Li_{6.5}La_{2.5}Ba_{0.5}ZrTaO₁₂ sample after soaking in D₂O;

FIG. 18 are charts illustrating in-situ variable temperature powder X-ray diffraction (PXRD) patterns at different temperatures of a Li_{6.5}La_{2.5}Ba_{0.5}ZrTaO₁₂ sample after soaking in 1M LiOH;

FIG. 19 are charts illustrating in-situ variable temperature powder X-ray diffraction (PXRD) patterns at different temperatures of a Li_{6.5}La_{2.5}Ba_{0.5}ZrTaO₁₂ sample after soaking in 1M LiCl,

FIG. 20 is a chart illustrating in-situ variable temperature powder X-ray diffraction (PXRD) patterns at different temperatures of an empty sample holder (for reference for FIGS. 17-19);

FIG. 21A is schematic illustration of a single-cell re-chargeable Li-air or a Li—S battery cell according to the present disclosure, with a ceramic tube separating the LLBZT anode from the porous cathode, while FIG. 21B is a close-up cross-sectional view of the configuration of the LLBZT anode next to the ceramic tubular wall which in turn, is next to the porous cathode which in turn, is next to the porous current collecting layer; and

FIG. 22A is an illustration of another example of a single-cell re-chargeable LLBZT Li-air battery cell according to the present disclosure, FIG. 22B shows two of the re-chargeable LLBZT Li-air or a Li—S battery cells shown in FIG. 22A coupled together in series, and FIG. 22C shows four of the re-chargeable LLBZT Li-air or a Li—S battery cells shown in FIG. 22A coupled together in series.

### DETAILED DESCRIPTION

The embodiments of the present disclosure relate to garnet-type structures such as Li_{6.5}La_{2.5}Ba_{0.5}ZrTaO₁₂ (also referred to herein as “LLBZT”) and related compounds, as a separator for elemental lithium and an aqueous electrolyte in an aqueous Li—O₂ battery architecture or in an aqueous Li—S battery architecture. LLBZT is referred as Lirich or Li-stuffed garnets because it contains more lithium than that can be accommodated in a classical garnet Li₃Ln₃Te₂O₁₂ (Ln=Y, Pr, Nd, Sm—Lu).

According to one embodiment, disclosed herein is a Li-rich garnet-type Li_{6.5}La_{2.5}Ba_{0.5}ZrTaO₁₂ (LLBZT) electrolyte suitable for use as a Li-protecting layer in aqueous Li—O₂ batteries. AC and DC electrical measurements, in addition to powder X-ray diffraction (PXRD), scanning electron microscopy (SEM), thermogravimetic analysis (TGA), were used to investigate the electrochemical and chemical properties of Li/LLBZT and LLBZT/aqueous interfaces. Stable open circuit voltages (OCV) of ˜3V were observed for Li/LLBZT/1MLiOH and Li/LLBZT/1MLiCl at 25° C. A DC galvanostatic Li plating/stripping cycle at varying constant current density was performed and the area specific polarization resistance (ASR) for Li-ion charge transfer was found to be 473Ω cm² at 25° C. The impedance of LLBZT garnet was improved after treating the samples with 1 M LiOH, and 1 M LiCl. The LLBZT garnet also retains its crystal structure and electrochemical stability with Li.

Accordingly, the Li-rich LLBZT garnet disclosed herein can be successfully employed in next-generation beyond Li-ion batteries as a separator in Li-air battery cells and in Li—S battery cells. The Li-rich LLBZT garnet is particularly suitable for incorporation into re-chargeable tubular battery cell configurations. Such re-chargeable Li-air battery cells may have up to four times the storage density of conventional Li-ion batteries. Such re-chargeable Li-air battery cells may be useful for incorporation into automotive battery configurations and applications. Such re-chargeable Li-air battery cells and Li—S battery cells may be useful for incorporation into portable electronics battery configurations and applications.

The following examples are provided to more fully describe the disclosure and are presented for non-limiting illustrative purposes.

### EXAMPLES

### Example 1

Li-rich garnet-type Li_{6.5}La_{2.5}Ba_{0.5}ZrTaO₁₂ (LLBZT) was prepared using conventional ceramic method using stoichiometric quantities of LiNO₃ (99%, Alfa Aesar), La₂O₃ (99.99%, Alfa Aesar) (dried at 900° C. for 12 h), Ta₂O₅ (99%, Alfa Aesar) ZrO₂ (99%, Alfa Aesar) and Ba(NO₃)₂ (98%, Alfa Aesar). 10 wt % excess LiNO₃ was added to compensate for lithium oxide volatilization during high-temperature sintering treatment. The synthesis process involved the conventional heating and ball milling steps. Planetary milling (Pulverisette, Fritsch, Germany) was used at a spinning rate of 200 rpm for 6 h using 2-propanol to ensure homogeneous mixing of the powders. Milling was performed before and after decomposition of metal nitrates. Nitrates were burned off by firing powder at 700° C. for 6 h under ambient conditions. The resultant powders were pressed into pellets using an isostatic press, placed on a powder bed, and covered with mother powder in a clean alumina crucible. Final sintering process involved 2 steps, 900° C. for 24 h and a final sintering of 1100° C. for 6 h in ambient atmosphere.

Ex-situ

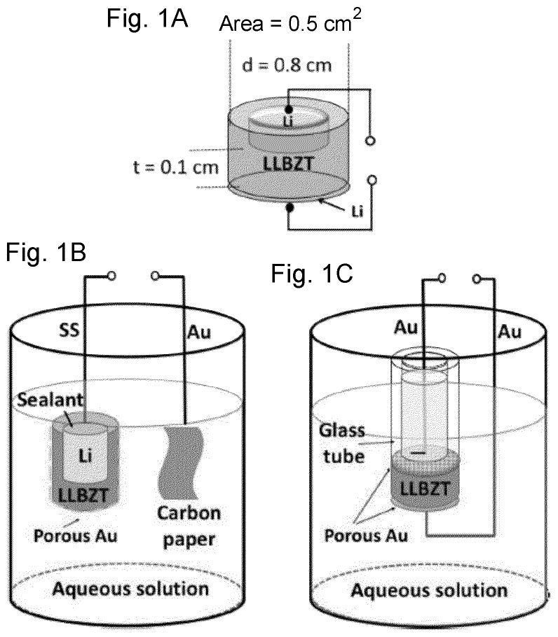

Powder X-ray diffraction (Powder X-ray Diffractometer, Model: Bruker D8 Advance) (Cu K_{α}, 40 kV, 40 mA) confirms the formation of garnet-type LLBZT. Measurements were performed from 2 θ range 10° to 80° at a count rate of 4 sec per step of 0.025° at room temperature. In-situ PXRD measurements using a high-temperature reactor chamber (Anton Paar XRK 900) in air were acquired from 2 θ range 10° to 80° at a count rate of 3 sec per step of 0.02°. FIGS. 1A-1C shows the schematic representation of the electrochemical cell used to investigate the stability of Li-rich LLBZT in various media and also with elemental Li. AC impedance spectroscopy (Solartron Model No: 1260; 0.1 Hz-1 MHz; 100 mV) was used to investigate the electrical conductivity of the samples. Highly porous gold-blocking electrodes were used as current collectors. Commercially available gold paste obtained from Heraeus Inc., Germany (LP A88-11S) was coated on the surface of pellets and cured at 700° C. for 1 h to remove the organic binder. Porosity of the gold layer was confirmed with scanning electron microscopy (Zeiss Sigma VP), with pores on the order of 10-20 μm.

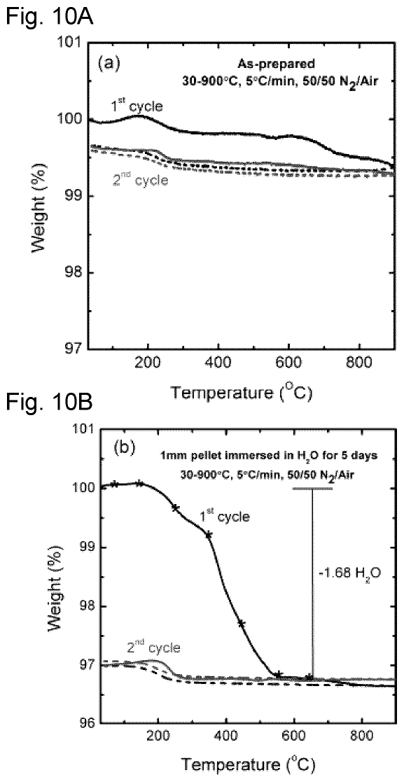

The stability of LLBZT in contact with Li metal was investigated under an argon-filled glove box (Innovative Technology, Inc.). A crucible-shaped sample of LLBZT was fabricated by isostatically pressing a powder sample of LLBZT inside an in-house-made polymer mold, with a load of 200 kN. The powder was pre-sintered at 900° C. for 12 h in air and then ball-milled for 6 h. The crucible-shaped sample was covered with the same powder and sintered at 1100° C. for 12 h. A schematic of the sample and the setup for stability experiments is shown in FIG. 1A. Lithium granules (99%, Alfa Aesar) were softened on top of a stainless-steel foil at ca. 180° C. and then the crucible-shaped LLBZT filled with Li granules for melting, was placed on top of the softened Li. To ensure that the surface of LLBZT was free of interference from surface contaminants during the preparation, several cycles of melting, removal, and refill of fresh lithium was performed prior to the measurements. DC measurements (galvanostatic cycling), specifically Li plating/stripping at varying constant current at room temperature were performed using a Solartron 1287 electrochemical interface. Impedance spectroscopy was performed at open circuit voltage (OCV) before and after Li plating/stripping using a Solartron 1260 impedance analyzer from 0.1 Hz-1M Hz at an amplitude of 100 mV. For Li/LLBZT/aqueous, a similar crucible shape LLBZT was used. The outside of the crucible was coated with a porous gold layer as shown in FIG. 1B. Conducting carbon electrode was immersed in the solution. OCV between Li and carbon electrode was measured using a potentiostat (PARSTAT 4000, Princeton applied research). Adhering 1 mm pellets to hollow quartz tube cylinders was used to perform aqueous stability of LLBZT in deionized water, D₂O, 1M LiOH and 1 M LiCl. Porous gold electrodes were coated at the surface of a pellet to serve as a current collector. These tubes were suspended in a 20-ml vial; the desired solution was poured into the tube as well as into the vial, as shown in FIG. 10. AC impedance of symmetrical aqueous cells was recorded for 10 days.

Chemical and Electrochemical Stabilities of Li_{6.5}La_{2.5}Ba_{0.5}ZrTaO₁₂ (LLBZT) with Elemental Li.

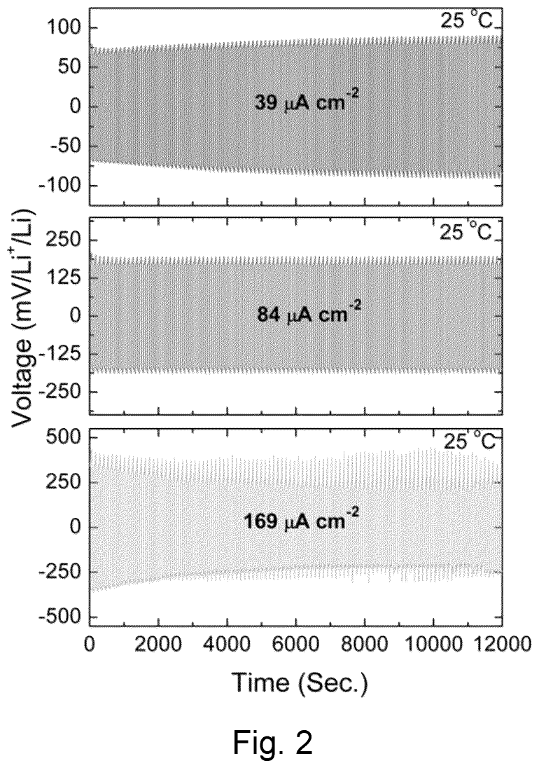

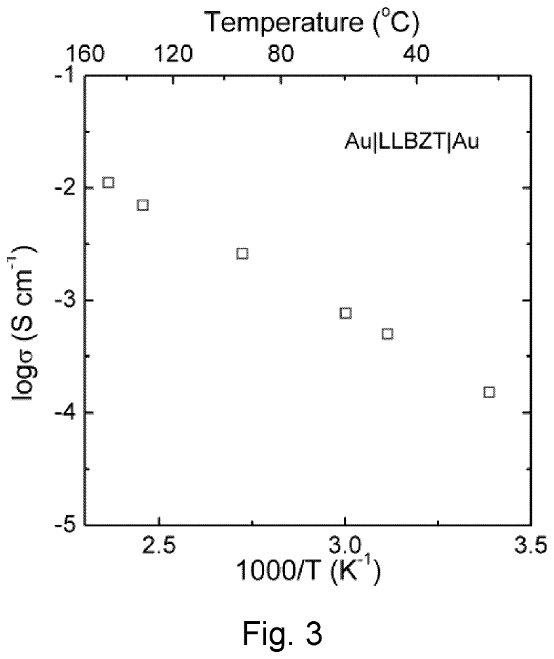

Li garnets can have wide electrochemical stability window (ESW) up to 9 V vs. Li⁺/Li. Table 1 shows a summary of the chemical stability of selected Li-rich garnet-type compositions including LLBZT, and their interfacial Li-ion charge transfer area specific polarization resistance (ASR) between Li and garnet. Cyclic voltammetry of the composition Li_{6.5}La_{2.5}Ba_{0.5}ZrTaO₁₂ revealed Li deposition and dissolution peaks near 0 V vs. Li⁺/Li, but indicated no other electrochemical reactions up to 6 V vs. Li⁺/Li. FIG. 2 shows the charging and discharging cycles of Li-rich garnet-type LLBZT under different current densities at 25° C. The plating and or stripping time were set to one minute. The ASR value for Li⁺ ion charge transfer can be estimated from the initial over-potentials associated with each current density. A linear fit of V vs. I of the data in Table 2 shows resistance (R) of 3200Ω at 25° C. The bulk resistance of the solid electrolyte LLBZT was obtained from Li⁺ ion blocking conductivity (FIGS. 2, 3, 4). The bulk resistance of the electrolyte was found to be 1308Ω at 25° C. Thus, the ASR for Li ion charge transfer, for symmetrical cell with area of 0.5 cm², can be estimated as: {(3200−1308)/2}0.5=473 Ωcm². The factor 2 divided the difference between the Li-reversible electrode and bulk impedance

TABLE 1

| | | | | Interfacial |
|---|---|---|---|---|
| | | Solid | | resistance |
| | | electrolyte | | between |
| | Li\|garnet\|Li | preparation | σ_{25° C.} | the Li and |
| | (pellet dimension) | condition | (S cm⁻¹) | electrolyte |
| 1 | Li₇La₃Zr₂O₁₂ (LLZ), pellet | Ceramic | 1.8 × | 4400 Ω |
| | dimensions are not reported | synthesis; | 10⁻⁴ | |
| | | 1230° C. | | |
| | | for 36 h | | |
| 2 | Li_{6.75}La₃(Zr_{1.75}Nb_{0.25})O₁₂, | Ceramic | 8.0 × | Not |
| | (d = 1.3 cm, t = 0.2 cm) | synthesis; | 10⁻⁴ | mentioned |
| | (Li\|garnet\|Au) | 1200° C. | | |
| | | for 36 h | | |
| 3 | Li_{6.625}La₃Zr_{1.625}Ta_{0.375}O₁₂ | Ceramic | 5.2 × | 99 Ω cm² |
| | with 29 mol % Al content | synthesis; | 10⁻⁴ | |
| | (d = 2.0 cm, t = 0.5 cm) | 1000° C. | | |
| | | for 20 h | | |
| 4 | Li₆La₃ZrTaO₁₂ | Ceramic | 2.6 × | 551 Ω cm² |
| | (d = 2.0 cm, t = 0.5 cm) | synthesis; | 10⁻⁴ | |
| | | 1000° C. | | |
| | | for 20 h | | |
| 5 | Li₇La₃Zr₂O₁₂ with 28 mol % | Ceramic | 3.5 × | 1398 Ω |
| | Al, (d = 2.0 cm, t = 0.5 cm) | synthesis; | 10⁻⁴ | cm² |
| | | 1230° C. | | |
| 6 | Li_{6.75} − ₓLa₃Zr_{1.75}Nb_{0.25} | Sol gel; | 5.69 × | 300 to |
| | O₁₂ − _{0.5x} with 0.46 wt % | 1150° C. | 10⁻⁴ | 492 Ω cm² |
| | Al₂O₃ (d = 1.0 cm, t = 0.1 | for 36 h | | |
| | cm) | | | |
| 7 | LLZ (d = 1.0 cm, t = 0.1 | Ceramic | 2.33 × | Not |
| | cm) | synthesis; | 10⁻⁴ | mentioned |
| | | 1180° C. | | |
| | | for 36 h | | |
| 8 | 0.5 wt % Al₂O₃-doped LLZ | Ceramic | 4.12 × | Not |
| | (d = 1.0 cm, t = 0.1 cm) | synthesis; | 10⁻⁴ | mentioned |
| | | 1180° C. | | |
| | | for 36 h | | |
| 9 | Li_{5.98}Al_{0.33}La₃Zr_{1.95}O_{11.89} | Ceramic | 2.5 × | 37 Ω cm² |
| | (d = 0.78 cm, t = 0.1 cm) | synthesis; | 10⁻⁴ | |
| | (Grain size: 20-40 μm) | 1100° C. | | |
| | | for 12 h | | |
| 10 | Li_{5.98}Al_{0.33}La₃Zr_{1.95}O_{11.89} | Ceramic | 2.0 × | 130 Ω cm² |
| | (d = 0.78 cm, t = 0.1 cm) | synthesis, | 10⁻⁴ | |
| | (Grain size: 100-200 μm) | 1100° C. | | |
| | | for 12 h | | |
| 11 | Li_{6.85}La_{2.9}Ca_{0.1}Zr_{1.75}Nb_{0.25}O₁₂ | Ceramic | 2.5 × | 925 Ω cm² |
| | | synthesis, | 10⁻⁴ | |
| | | 1050° C. | | |
| | | for 12 h | | |
| 12 | Si-coated | Ceramic | 2.5 × | 127 Ω cm² |
| | Li_{6.85}La_{2.9}Ca_{0.1}Zr_{1.75}Nb_{0.25}O₁₂ | synthesis, | 10⁻⁴ | |
| | | 1050° C. | | |
| | | for 12 h | | |
| 13 | Li_{6.5}La_{2.5}Ba_{0.5}ZrTaO₁₂ | Ceramic | 1.5 × | 473 Ω cm² |
| | (LLBZT) | synthesis; | 10⁻⁴ | |
| | | 1100° C. | | |
| | | for 12 h | | |

| | Stability testing and comments | Reference |
|---|---|---|
| 1 | CV (−0.2 to 0.4 V, 10 mV min⁻¹); dissolution and | [26] |
| | deposition reactions of Li were observed reversibly. | |
| | Chronopotentiometry (10 to 50 μA cm⁻²); Up to 10 | |
| | μA cm⁻², the dissolution and deposition curves gave | |
| | the mirrored relationship at least until 600 s. | |
| 2 | CV (−0.5 to 9 V, 1 mV s⁻¹); Li deposition and | [27] |
| | dissolution peaks are observed near 0 V vs. Li⁺/Li, | |
| 3 | CV (−0.1 to 0.1 V, 1 mV s⁻¹); Linear behavior | [22] |
| | indicates reversibility of the electrode process. | |
| 4 | CV (−0.1 to 0.1 V, 1 mV s⁻¹); Linear behavior | [22] |
| | indicates reversibility of the electrode process. | |
| 5 | CV (−0.1 to 0.1 V, 1 mV s⁻¹); Linear behavior | [32] |
| | indicates reversibility of the electrode process. | |
| 6 | EIS monitoring for long-term stored samples (up to | [28] |
| | 5 months); increase in interfacial resistance suggests | |
| | that the Nb in the compound that is in contact with | |
| | Li may be reduced slightly. | |
| 7 | EIS monitoring for long term stored samples (up to 1 | [30] |
| | month); The resistance of the cell decreased with | |
| | storage period for the first one week and then became | |
| | stable for one month at room temperature | |
| | Chronopotentiometry (0.5 mA cm⁻²); Abrupt drop in | |
| | cell voltage after 122 s of Polarization | |
| 8 | EIS monitoring for long term stored samples (up to 1 | [30] |
| | month); The resistance of the cell decreased with | |
| | storage period for the first one week and then became | |
| | stable for one month at room temperature | |
| | Chronopotentiometry (0.5 mA cm⁻²); Abrupt drop in | |
| | cell voltage after 1000 s of polarization | |
| 9 | Galvanostatic cycling (up to 134 μA cm⁻²); The | [31] |
| | potential of the cell remains constant at different | |
| | current densities and increased linearly at higher | |
| | current densities up to 134 μA cm⁻². Above this | |
| | value, the cell exhibited voltage instability and | |
| | shortcircuited. | |
| 10 | Galvanostatic cycling (up to 90 μA cm⁻²); The cell | [31] |
| | shorted during the 2 h period at the current density of | |
| | 90 μA cm⁻². | |
| 11 | Galvanostatic cycling (0.05 mA cm⁻²); Voltage | [29] |
| | hysteresis is large and the plating/stripping curves | |
| | are unstable | |
| 12 | Galvanostatic cycling (up to 0.2 mA cm⁻²); Voltage | [29] |
| | profiles exhibited flat and stable plating and stripping | |
| | curves with small over-potential. Voltage profile | |
| | remained stable after cycling for 225 h (0.1 or 0.05 | |
| | mA cm⁻²) | |
| 13 | Galvanostatic cycling up to 169 μA cm⁻² | This study |

TABLE 2

| Current density (A cm⁻²) | Voltage (V) | Current (A) |
|---|---|---|
| 39 × 10⁻⁶ | 0.08 | 1.98 × 10⁻⁵ |
| 84 × 10⁻⁶ | 0.17 | 4.24 × 10⁻⁵ |
| 169 × 10⁻⁶ | 0.25 | 8.48 × 10⁻⁵ |

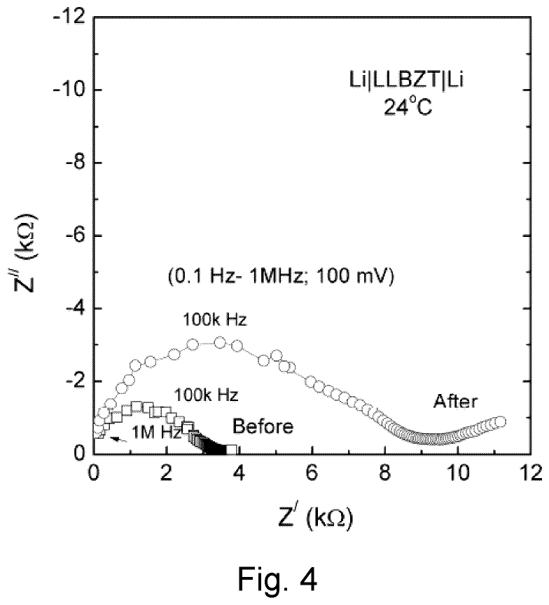

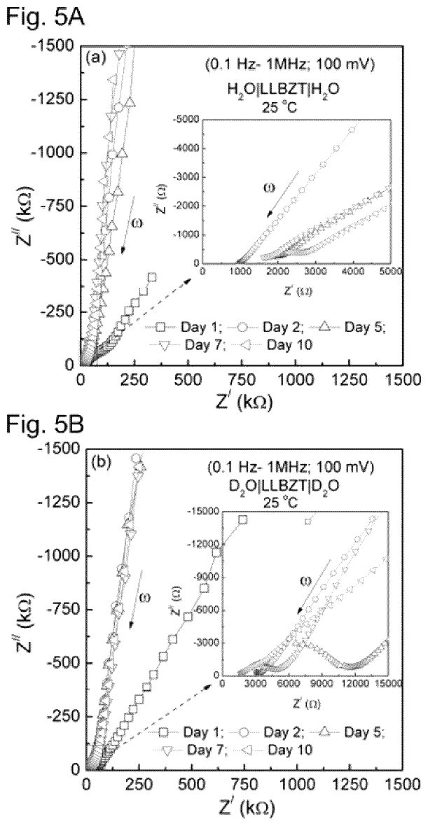

because a symmetrical cell was used. Another way to estimate the ASR is by looking at difference in the total resistance, obtained through electrochemical ac impedance spectroscopy of Li non-blocking cell: Li|LLBZT|Li (FIG. 5). The total cell resistance of ca. 3500Ω is comparable to the estimated resistance from the galvanostatic cycling. By subtracting the resistance of the electrolyte (1308Ω), and dividing by a factor of two, the interfacial resistance of Li|LLBZT was 1096Ω, and the ASR was 548 Ωcm² which is slightly higher than that of DC ASR value. Also, it is apparent from FIG. 4 that the interfacial resistance significantly increased after galvanostatic cycling. The higher charge transfer ASR value in the present study could be attributed to potential interface reaction products and contact resistance between Li and LLBZT.
Chemical and Electrochemical Stabilities of Li_{6.5}La_{2.5}Ba_{0.5}ZrTaO₁₂ (LLBZT) with Aqueous Solutions.

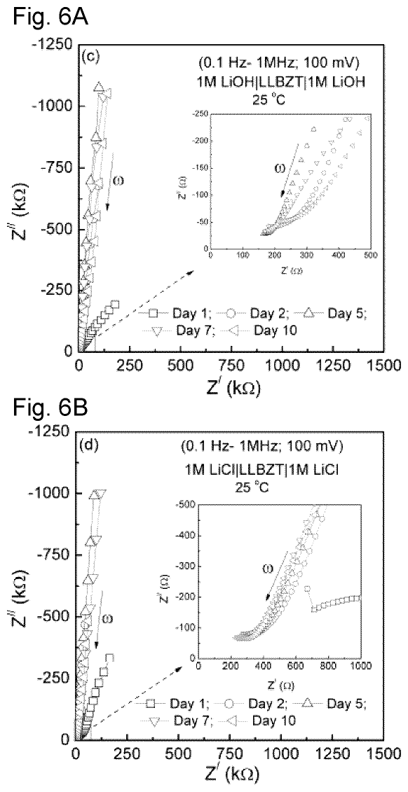

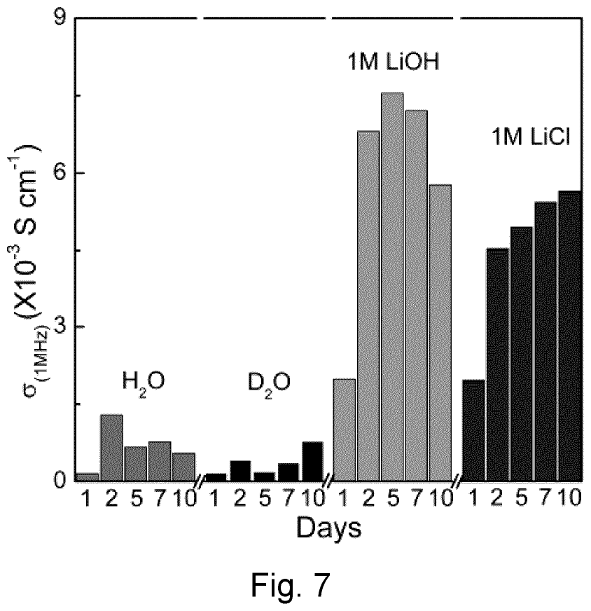

The chemical stability of Li-rich LLBZT in deionized water, D₂O and aqueous Li⁺ solutions was studied using AC impedance spectroscopy at room temperature to assess its application in beyond Li-ion batteries. FIGS. 5A, 5B, 6A, 6B show the variation of AC impedance plots of LLBZT in H₂O, D₂O, 1M LiOH, and 1M LiCl for 10 days (using the experimental design shown in FIG. 1C). The shape of the impedance plots was typical for Li garnets with Au-blocking electrodes study. In all the cases, the low-frequency regime showed a tail as a consequence of the blocking nature of the electrodes. The bulk impedance decreased in all solutions after the first day. The studies with 1M LiOH, and 1M LiCl solutions showed a gradual decrease in bulk impedance with increasing time. After 10 days, the bulk impedance of the samples was found to follow the order: 1M LiOH<1MLiCl<D₂O<H₂O at room temperature. The bulk impedance was found to have small variation in LiCl and LiOH compared to H₂O and D₂O. Shown in FIG. 7 is the bulk electrical conductivity value obtained from 1 MHz impedance.

It is also known that Li-rich garnets tend to undergo fast proton exchange in water and in aqueous LiOH/LiCl and deuterium exchange in D₂O. A slight increase in the impedance in D₂O compared to water indicates that potential proton migration in water since mobility of ions depends on charge and mass of the mobile species. The improvement in the bulk ionic conductivity for LLBZT in the aqueous mediums with time may be considered due to increase in mobile charge carries. We believe that either partial exchange of protons in Li garnets may change the mobile path of Li ions that seem to increase the electrical mobility of Li ions in the garnet-type structure.

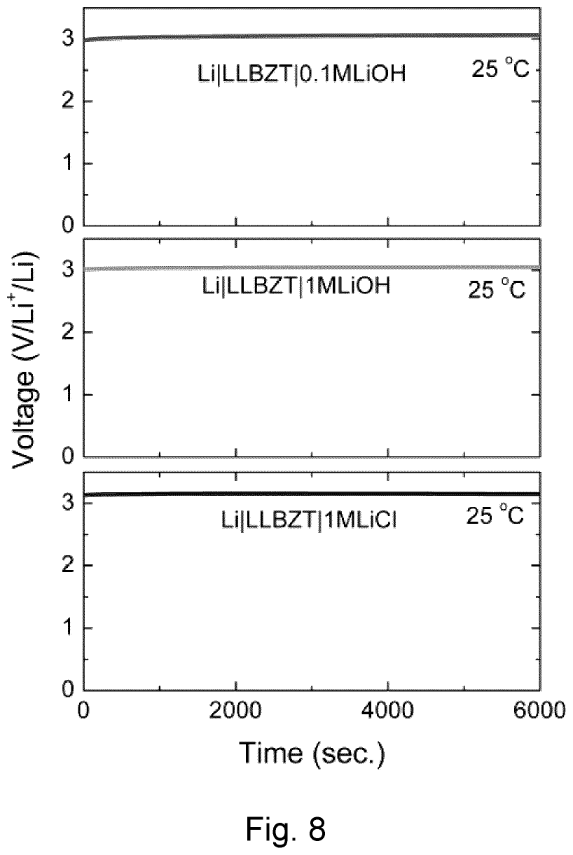

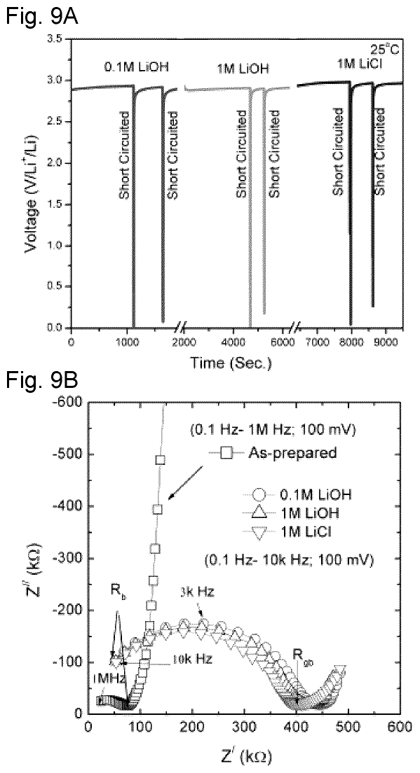

Li-rich garnet structures are known to show reversible Li⁺/H⁺ ion-exchange in water and organic acids. To further understand the chemical/structural stability of Li-rich garnet-type LLBZT with LiOH and LiCl, variation of open circuit voltage (OCV) of the Li-aqueous cells: Li/LLBZT/0.1 M LiOH, Li/LLBZT/1M LiOH, and Li/LLBZT/1M LiCl, was measured as a function of time at room temperature (25° C.), as seen in FIG. 8. The OCV of the cell (˜3 vs. Li) was found to be constant over the recorded time and it was found to highly reproducible. The observed voltage was also found to be very reliable and stable when replacing different solutions and returned to original value after intentional short-circuit test (FIG. 9A). The observed voltage of Li aqueous cell can be described using the reaction [41]:

Anode side reaction: 2Li→2Li⁺+2e⁻ Eq. 1

Cathode side reaction: O₂+H₂O+2e⁻→OH⁻+HO²⁻ Eq. 2

Overall reaction: 2Li+O₂+H₂O→LiOH+Li⁺+HO²⁻ Eq. 3

Depending upon pH and nature of electrode catalysts, the oxygen reduction reaction (ORR) follows two electrons and/or four electrons paths in alkaline solution leading to difference reaction products such as Li₂O₂. The former show OCV of about 3.0 V/Li while the latter show 3.45 V/Li. The four-have different dehydration energy. For compete replacement of Li by protons, i.e.,

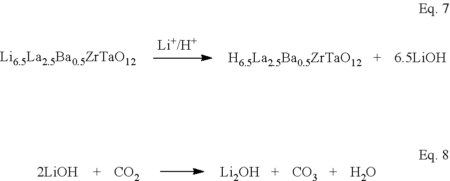

The total proton exchange is anticipated 6.6 wt % loss for the loss of 3.25 moles of water. The Ta-doped garnets experienced adsorbed water loss around 250° C., H⁺ release in the form of H₂O around 400-450° C. and CO₂ loss above 550° C. All weight lost up to 550° C. to be from H₂O. Equations 9-12 show the anticipated ion-exchange reaction after 5 days, based on the TGA weight loss experiments.

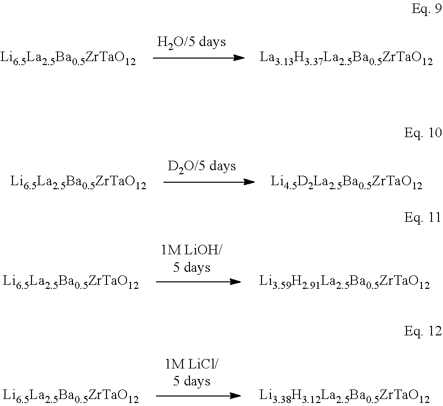

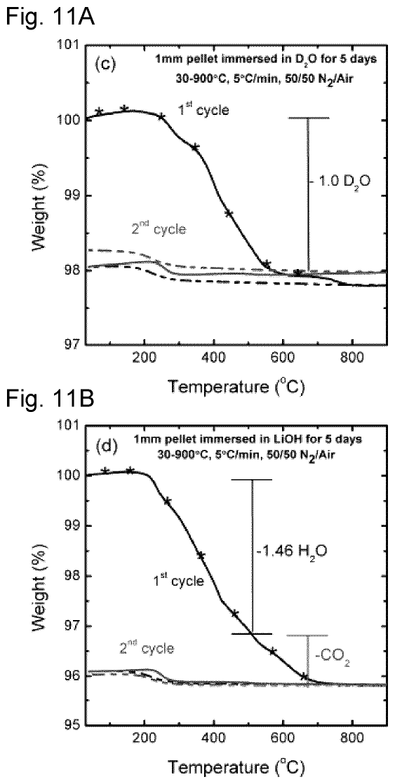

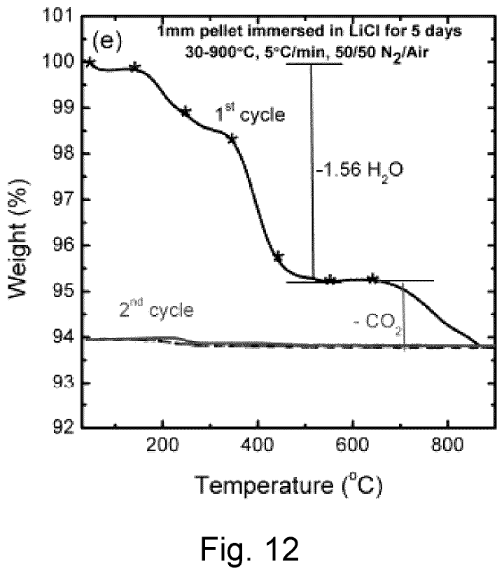

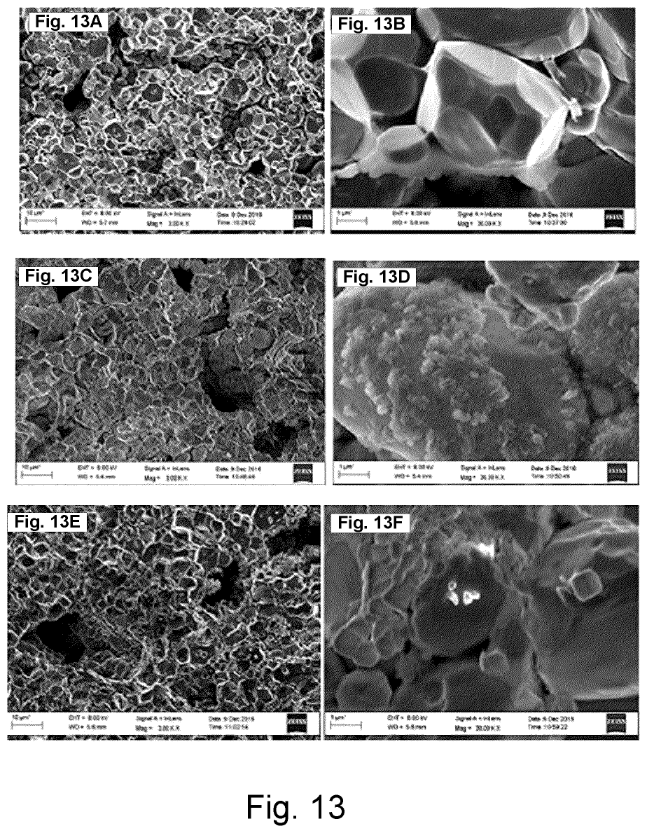

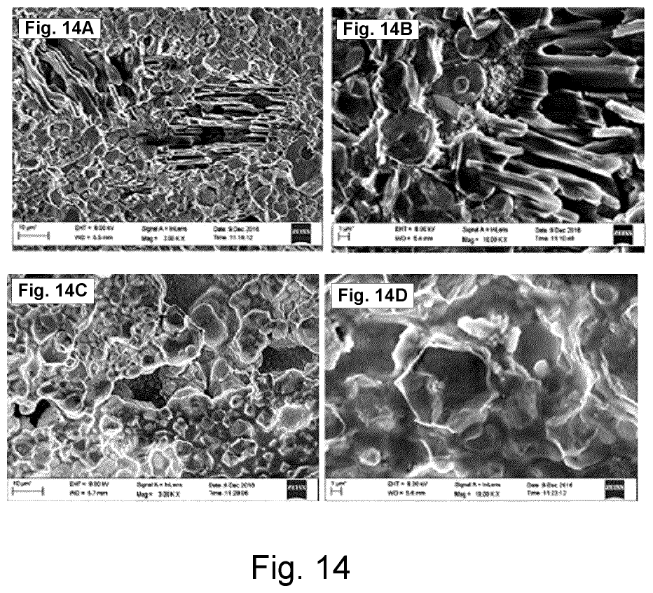

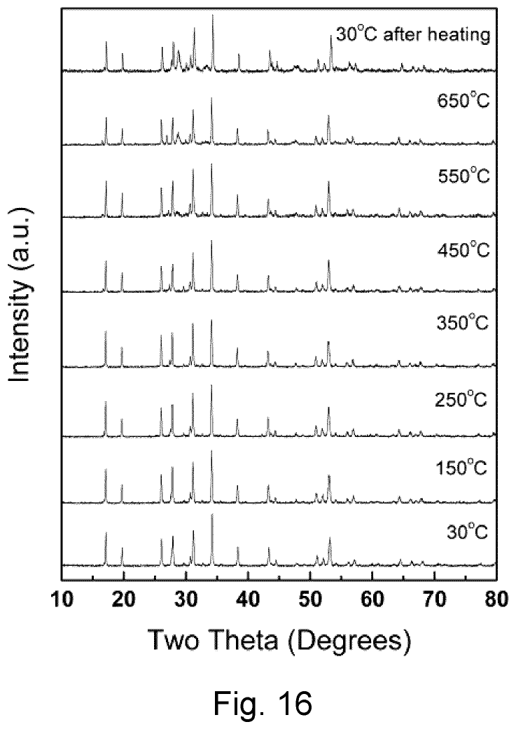

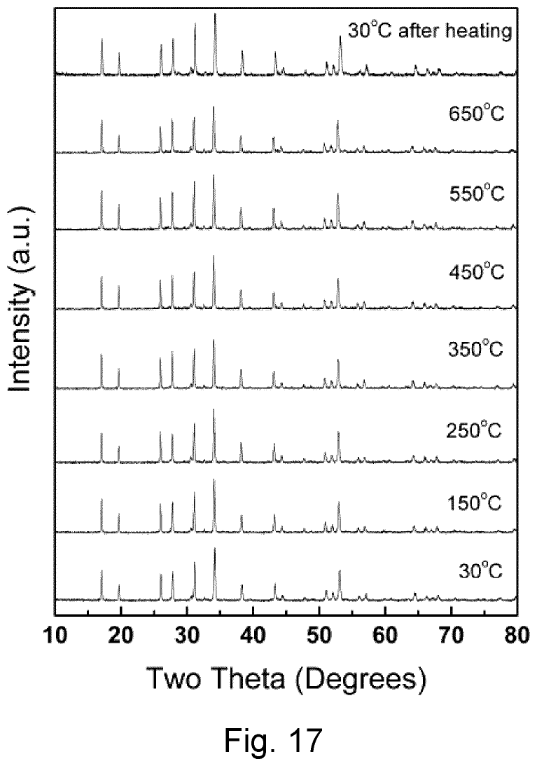

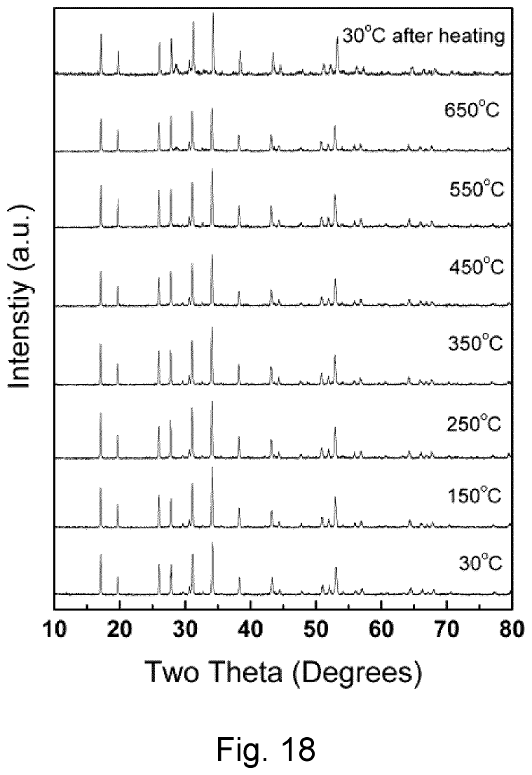

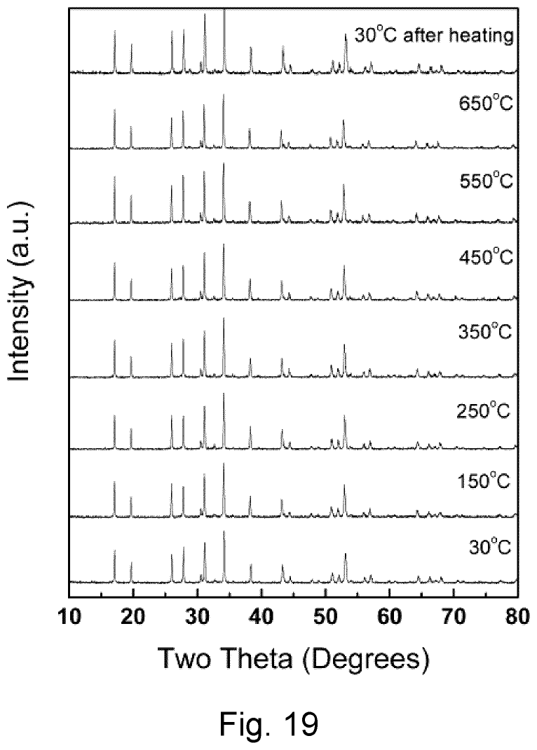

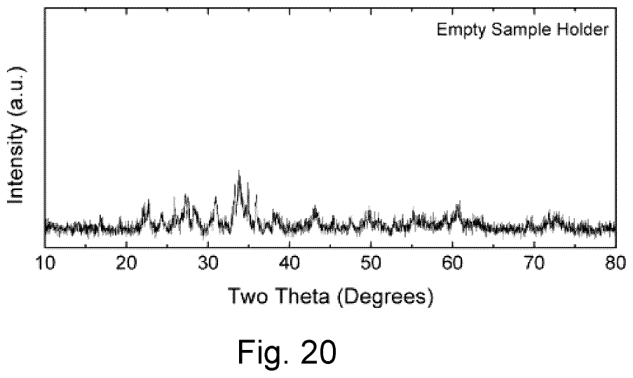

The as-prepared samples also show ca. 0.5 wt. %. The second heating and cooling cycles do not show any weight loss, which further support the adsorption of CO₂ and moisture (FIGS. 10A, 10B, 11A, 11B, 12). Scanning electron microscopy images (FIGS. 13A-13F, 14A-14D) of LiOH and LiCl treated samples were found to have different morphology than those of the as-prepared and H₂O/D₂O soaked samples. The structural stability of the solution treated samples were studied with in-situ PXRD in the temperature range of 30-650° C. In all cases the garnet-type structure was retained even up to the maximum temperature of 650° C. (FIGS. 16-19). The weak additional peaks in FIGS. 16, 17, 18, 19 appear due to sample holder contribution. For comparison, PXRD of an empty alumina sample holder used for HT-PXRD is shown in FIG. 20. Coupling this with the TGA data, this would enforce that the weight loss was due to adsorbed carbonate and moister rather than the decomposition of the garnet crystal structure.

have different dehydration energy. For compete replacement of Li by protons, i.e.,

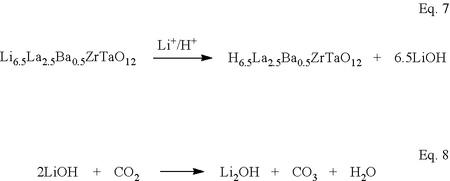

The total proton exchange is anticipated 6.6 wt % loss for the loss of 3.25 moles of water. The Ta-doped garnets experienced adsorbed water loss around 250° C., H⁺ release in the form of H₂O around 400-450° C. and CO₂ loss above 550° C. All weight lost up to 550° C. to be from H₂O. Equations 9-12 show the anticipated ion-exchange reaction after 5 days, based on the TGA weight loss experiments.

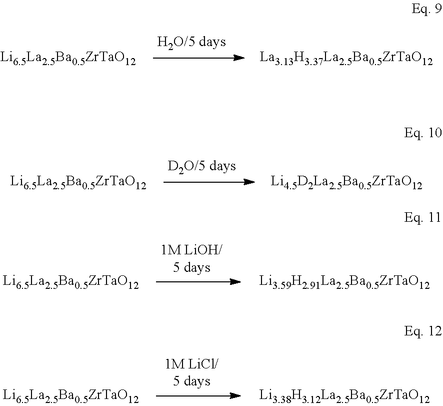

The as-prepared samples also show ca. 0.5 wt. %. The second heating and cooling cycles do not show any weight loss, which further support the adsorption of CO₂ and moisture (FIGS. 10A, 10B, 11A, 11B, 12). Scanning electron microscopy images (FIGS. 13A-13F, 14A-14D) of LiOH and LiCl treated samples were found to have different morphology than those of the as-prepared and H₂O/D₂O soaked samples. The structural stability of the solution treated samples were studied with in-situ PXRD in the temperature range of 30-650° C. In all cases the garnet-type structure was retained even up to the maximum temperature of 650° C. (FIGS. 16-19). The weak additional peaks in FIGS. 16, 17, 18, 19 appear due to sample holder contribution. For comparison, PXRD of an empty alumina sample holder used for HT-PXRD is shown in FIG. 20. Coupling this with the TGA data, this would enforce that the weight loss was due to adsorbed carbonate and moister rather than the decomposition of the garnet crystal structure.

The present study shows that Li-rich garnet-type Li_{6.5}La_{2.5}Ba_{0.5}ZrTaO₁₂ (LLBZT) was found to be structurally stable after exposure to H₂O, D₂O, 1M LiOH, and 1M LiCl for 10 days at room temperature. TGA analysis showed partial exchange of Li ions by protons in LLBZT after exposed to H2O, 1M LiOH, and 1M LiCl and deuterium exchange in D2O. Tandem temperature variable PXRD measurements show that the garnet structure is retained after solution treatment and heating. After 10 days, the bulk impedance of the samples was found to follow the order: 1M LiOH<1M LiCl<D2O<H2O. The bulk impedance was found to be varying rather small in LiCl and LiOH compared to water and D2O. The open circuit voltage (OCV) of the Li-aqueous cells: Li/LLBZT/0.1MLiOH, Li/LLBZT/1MLiOH, and Li/LLBZT/1MLiCl showed 3 V vs. Li and it was found to be constant over the recorded time and highly reproducible. The lower OCV was explained using poor catalytic activity of electrodes used. The absence of short-circuit voltage suggest that presently investigated garnet-type oxide is stable with elemental Li and LiOH and LiCl solutions.

It is to be noted that the barium (Ba) component of the Li_{6.5}La_{2.5}Ba_{0.5}ZrTaO₁₂ electrolyte may be substituted with another alkaline rare earth metal. For example, beryllium (Be), magnesium (Mg), calcium (Ca), strontium (Sr), or radium (Ra), or lanthanum (La) in varying concentrations. In addition, the tantalum (Ta) component of the Li_{6.5}La_{2.5}Ba_{0.5}ZrTaO₁₂ electrolyte may be substituted with Niobium (Nb) or Zirconium (Zr) in varying concentrations.

### Example 2

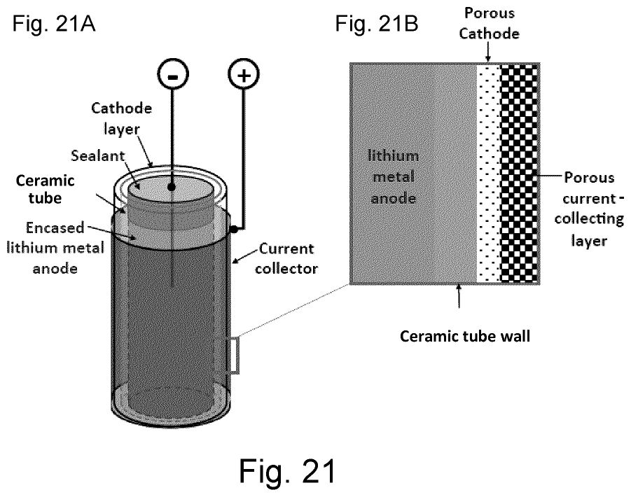

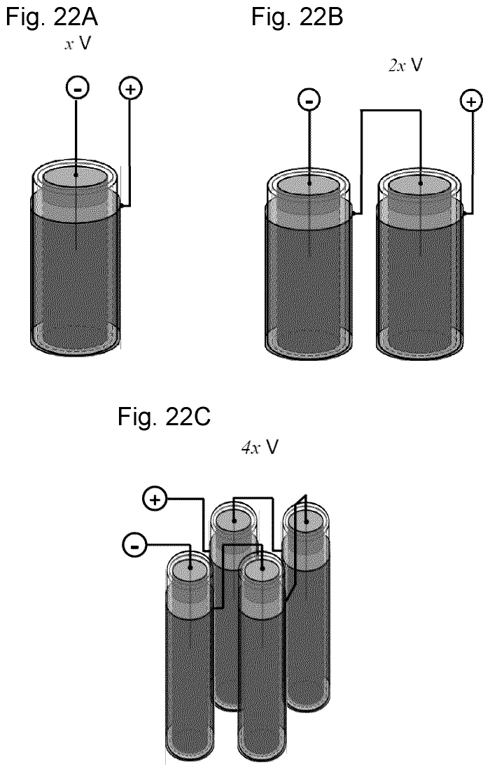

Examples of tubular re-chargeable Li-air battery cells comprising the Li-rich garnet-type Li_{6.5}La_{2.5}Ba_{0.5}ZrTaO₁₂ (LLBZT) disclosed herein are illustrated in FIGS. 21 and 22. FIG. 21A is a schematic illustration of an example of a single-cell re-chargeable Li-air battery cell according to the present disclosure, with a ceramic tube separating the LLBZT anode from the porous cathode, while FIG. 21B is a close-up cross-sectional view of the configuration of the LLBZT anode next to the ceramic tubular wall which in turn, is next to the porous cathode which in turn, is next to the porous current collecting layer. FIG. 22A is an illustration of another example of a single-cell re-chargeable LLBZT Li-air battery cell or a LLBZT Li—S battery cell according to the present disclosure, FIG. 22B shows two of the re-chargeable LLBZT Li-air battery cells or a LLBZT Li—S battery cells shown in FIG. 22A coupled together in series, and FIG. 22C shows four of the re-chargeable LLBZT Li-air battery cells or a LLBZT Li—S battery cells shown in FIG. 22A coupled together in series.

### REFERENCES (FROM TABLE 1)

22. Buschmann, H., et al. (2012) Lithium metal electrode kinetics and ionic conductivity of the solid lithium ion conductors “Li₇La₃Zr₂O₁₂” and Li₇₋ₓLa₃Zr₂₋ₓTaₓO₁₂ with garnet-type structure, J. Power Sources 206: 236-244.
26. Kotobuki, M., et al. (2010) Compatibility of Li₇La₃Zr₂O₁₂ solid electrolyte to all-solid-state battery using Li metal anode, J. Electrochem. Soc. 157:A1076-A1079.
27. Ohta, S., et al. (2011) High lithium ionic conductivity in the garnet-type oxide Li₇₋ₓLa₃(Zr₂₋ₓ, Nbₓ)O₁₂ (X=0-2), J. Power Sources 196: 3342-3345.
28. Ishiguro, K., et al. (2013) Stability of Nb-doped cubic Li₇La₃Zr₂O₁₂ with lithium metal, J. Electrochem. Soc. 160:A1690-A1693.
29. Luo, W., et al. (2016) Transition from Superlithiophobicity to Superlithiophilicity of garnet solid-state electrolyte, J. Am. Chem. Soc. 138: 12258-12262.
30. Sudo, R., et al. (2014) Interface behavior between garnet-type lithium-conducting solid electrolyte and lithium metal, Solid State Ionics 262: 151-154.
31. Cheng, L., et al. (2015) Effect of surface microstructure on electrochemical performance of garnet solid electrolytes, ACS Appl. Mater. Interfaces 7: 2073-2081.
32. Buschmann, H., et al. (2011) Structure and dynamics of the fast lithium ion conductor “Li₇La₃Zr₂O₁₂”, Phys. Chem. Chem. Phys. 13: 19378-19392.

1. A re-chargeable Li-air battery cell comprising a Li-rich garnet-type Li_{6.5}La_{2.5}Ba_{0.5}ZrTaO₁₂ electrolyte as a separator, wherein the Li-rich garnet-type Li_{6.5}La_{2.5}Ba_{0.5}ZrTaO₁₂ electrolyte is adjacent to a ceramic wall which in turn, is adjacent to a porous cathode or a dense cathode which in turn, is adjacent to a porous current-collecting layer.

2. (canceled)

3. A re-chargeable Li-air battery comprising two or more re-chargeable Li-air battery cells according to claim 1, wherein said two or more re-chargeable Li-air battery cells are connected in series.

4. A re-chargeable Li-air battery cell according to claim 1, wherein the barium component of the Li-rich garnet-type Li_{6.5}La_{2.5}Ba_{0.5}ZrTaO₁₂ electrolyte, is doped with an alkaline rare earth metal and/or the Tantalum component is doped with Niobium or Lanthanum.

5. A re-chargeable Li-air battery cell according to claim 4, wherein the alkaline rare earth metal is one of beryllium, magnesium, calcium, strontium, and radium.

6. An aqueous Li-air battery cell comprising a Li-rich garnet-type Li_{6.5}La_{2.5}Ba_{0.5}ZrTaO₁₂ electrolyte as a Li-protecting layer, wherein the Li-rich garnet-type Li_{6.5}La_{2.5}Ba_{0.5}ZrTaO₁₂ electrolyte is adjacent to a ceramic wall which in turn, is adjacent to a porous cathode or a dense cathode which in turn, is adjacent to a porous current-collecting layer.

7. A re-chargeable Li—S battery cell comprising a Li-rich garnet-type Li_{6.5}La_{2.5}Ba_{0.5}ZrTaO₁₂ electrolyte as a separator, wherein the Li-rich garnet-type Li_{6.5}La_{2.5}Ba_{0.5}ZrTaO₁₂ electrolyte is adjacent to a ceramic wall which in turn, is adjacent to a porous cathode or a dense cathode which in turn, is adjacent to a porous current-collecting layer.

8. (canceled)

9. A re-chargeable Li—S battery comprising two or more re-chargeable Li—S battery cells according to claim 7, wherein said two or more re-chargeable Li—S battery cells are connected in series.

10. A re-chargeable Li—S battery cell according to claim 7, wherein the barium component of the Li-rich garnet-type Li_{6.5}La_{2.5}Ba_{0.5}ZrTaO₁₂ electrolyte is doped with an alkaline rare earth metal and/or the tantalum component is doped with niobium or lanthanum.

11. A re-chargeable Li—S battery cell according to claim 10, wherein the alkaline rare earth metal is one of beryllium, magnesium, calcium, strontium, and radium.

12. An aqueous Li—S battery cell comprising a Li-rich garnet-type Li_{6.5}La_{2.5}Ba_{0.5}ZrTaO₁₂ electrolyte as a Li-protecting layer, wherein the Li-rich garnet-type Li_{6.5}La_{2.5}Ba_{0.5}ZrTaO₁₂ electrolyte is adjacent to a ceramic wall which in turn, is adjacent to a porous cathode or a dense cathode which in turn, is adjacent to a porous current-collecting layer.

13. The re-chargeable Li-air battery cell of claim 1, wherein the cell is a tubular cell.

14. The re-chargeable Li-air battery cell of claim 1, wherein the ceramic wall is a ceramic tubular wall.

15. The aqueous Li-air battery cell of claim 6, wherein the ceramic wall is a ceramic tubular wall.

16. The re-chargeable Li—S battery cell of claim 7, wherein the cell is a tubular cell.

17. The re-chargeable Li—S battery cell of claim 7, wherein the ceramic wall is a ceramic tubular wall.

18. The aqueous Li—S battery cell of claim 12, wherein the ceramic wall is a ceramic tubular wall.
